(19) United States
(12) Patent Application Publication
(10) Pub. No.: US 2017/0293722 A1
(43) Pub. Date: Oct. 12, 2017

(54) Insurance Evaluation Engine

(71) Applicant: Amgine Technologies (US), Inc., Austin, TX (US)

(72) Inventors: L. James Valverde, JR., Washington, DC (US); Harold Roy Miller, Toronto (CA); Jonathan David Miller, Toronto (CA)

(21) Appl. No.: 15/482,619

(22) Filed: Apr. 7, 2017

Related U.S. Application Data
(60) Provisional application No. 62/321,054, filed on Apr. 11, 2016.

(51) Int. Cl. G06F 19/00

(52) U.S. Cl. CPC G06F 19/328; G06F 19/322

(57) ABSTRACT

A method and a system for evaluating a cost of insurance are provided. The method may commence with parsing a text from medical information sources to obtain statistical data associated with a population of patients. The method may further include structuring the statistical data to form structured medical metadata in an intelligent medical database. Based on the structured medical metadata, a causal network may be created. The method may continue with receiving health data associated with a patient from one or more patient data sources. The health data may be parsed to obtain processed patient health data. The method may further include mapping the processed patient health data against the causal network. Based on the mapping, a future health status associated with the patient may be predicted. The method may continue with evaluating the cost of the insurance associated with the patient based on the future health status.

### CROSS-REFERENCE TO RELATED APPLICATIONS

The present utility patent application is related to and claims the priority benefit under 35 U.S.C. 119(e) of U.S. provisional application No. 62/321,054, filed on Apr. 11, 2016, and titled “Insurance Evaluation Engine”. The disclosure of this related provisional application is incorporated herein by reference for all purposes to the extent that such subject matter is not inconsistent herewith or limiting hereof.

### TECHNICAL FIELD

The application relates generally to data processing, and, more specifically, to predicting healthcare expenses.

### BACKGROUND

Electronic medical records (EMRs) can digitally store information found in traditional paper-based records. When compared to the paper-based records, the EMRs are more organized, accurate, and simpler to acquire and store. However, the EMRs associated with a patient can be fragmented between different health care providers. As a result, insurance companies may not have an integrated view of patient data, and, consequently, lack the comprehensive medical history necessary for proper evaluation of costs associated with an insurance policy. In view of absence of the integrated view of the patient data, it may be impossible to predict future health issues of a patient, identify diseases, disease progress, and consequences of the future health issues for the patient. Moreover, difficulties may be faced when determining possible treatments and associated expenses for the patient.

Moreover, even though the insurance companies may request the EMRs associated with the patient from health care providers, the time needed for the health care providers to collect and provide the EMRs to the insurance companies may postpone calculating insurance-associated expenses for the patient by the insurance companies.

### SUMMARY

This summary is provided to introduce a selection of concepts in a simplified form that are further described in the Detailed Description below. This summary is not intended to identify key features or essential features of the claimed subject matter, nor is it intended to be used as an aid in determining the scope of the claimed subject matter.

The present disclosure is related to approaches for predicting costs associated with an insurance. According to one approach of the present disclosure, a system for evaluating a cost of an insurance is provided. The system may include a first parser, a second parser, and a processor. The first parser may be configured to parse a text from one or more medical information sources to obtain statistical data associated with a population of patients. The processor may be configured to structure the statistical data to form structured medical metadata in an intelligent medical database. The processor may be further configured to create, based on the structured medical metadata, a causal network. The processor may be configured to receive health data associated with a patient from one or more patient data sources. The second parser may be configured to parse the health data associated with the patient to obtain processed patient health data. The processor may be further configured to map the processed patient health data against the causal network. Based on the mapping, the processor may predict a future health status associated with the patient. The processor may be further configured to evaluate, based on the future health status, the cost of the insurance associated with the patient.

According to another approach of the present disclosure, a method for evaluating costs associated with an insurance is provided. The method may commence with parsing a text from medical information sources to obtain statistical data associated with a population of patients. The method may further include structuring the statistical data to form structured medical metadata in an intelligent medical database. Based on the structured medical metadata, a causal network may be created. The method may continue with receiving health data associated with a patient from one or more patient data sources. The health data may be parsed to obtain processed patient health data. The method may further include mapping the processed patient health data against the causal network. Based on the mapping, a future health status associated with the patient may be predicted. The method may continue with evaluating the cost of the insurance associated with the patient based on the future health status.

In further example embodiments of the present disclosure, the method operations are stored on a machine-readable medium comprising instructions, which, when implemented by one or more processors, perform the recited operations. In yet further example embodiments, hardware systems or devices can be adapted to perform the recited operations. Other features, examples, and embodiments are described below.

### BRIEF DESCRIPTION OF THE DRAWINGS

Embodiments are illustrated by way of example, and not limitation, in the figures of the accompanying drawings, in which like references indicate similar elements.

FIG. 1 illustrates a block diagram showing a sample environment within which methods and systems for evaluating a cost of insurance may be implemented.

FIG. 2 is block diagram showing various modules of a system for evaluating a cost of insurance.

FIG. 3 is a block diagram illustrating a system for evaluating a cost of insurance.

FIG. 4 is a flow chart illustrating a method for evaluating a cost of insurance.

FIG. 5 illustrates a causal network.

FIG. 6 illustrates a user interface associated with a metadata library.

FIG. 7 illustrates a diagrammatic representation of an example machine in the form of a computer system within which a set of instructions for causing the machine to perform any one or more of the methodologies discussed herein is executed.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is therefore not to be taken in a limiting sense, and the scope is defined by the appended claims and their equivalents. In this document, the terms “a” and “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

The techniques of the embodiments disclosed herein may be implemented using a variety of technologies. For example, the methods described herein may be implemented in software executing on a computer system or in hardware utilizing either a combination of microprocessors or other specially designed application-specific integrated circuits, programmable logic devices, or various combinations thereof. In particular, the methods described herein may be implemented by a series of computer-executable instructions residing on a storage medium, such as a disk drive or computer-readable medium. It should be noted that methods disclosed herein can be implemented by a computer (e.g., a desktop computer, a tablet computer, a laptop computer, and so forth), a game console, a handheld gaming device, a cellular phone, a smart phone, a smart television system, and so forth.

As outlined in the summary, the embodiments of the present disclosure are directed to evaluating a cost of an insurance. A system for evaluating a cost of an insurance may have an insurance evaluation engine that may be integrated into the system for evaluating a cost of an insurance. In general, the insurance evaluation engine may be designed to determine future health issues of a patient, accompanying healthcare expenses, recommended treatments, and patient management plans. The insurance evaluation engine may be based on inference and statistics instead of pathology or clinical gestalt. More specifically, the insurance evaluation engine of the system for evaluating a cost of an insurance may include two natural language parsers. The first (backend) parser may be responsible for reading medical literature (journals, standards, medical records, and the like) and building backend structures that may form a framework of the intelligence of the system for evaluating a cost of an insurance. The second (frontend) parser may read and parse texts of EMRs, take pertinent statistical data associated with a population of patients, and feed the statistical data to the backend structures. The backend structures may be subsystems of an intelligent medical database, which may store all relevant information pertaining to the population of patients in a structured form. The system for evaluating a cost of an insurance may further include a causal network, also referred to as a teleological network, which may be configured to connect various symptoms, treatments, and diseases in a way that cannot be performed by a database table, and in more ways than an average physician can remember at any given time.

Moreover, two inference models may be used in the system for evaluating a cost of an insurance. One inference model may be used with the second parser to help determine medical terms and phrases associated with a health status of a patient. The other inference model may be used with the first parser to use the available statistical data to determine a probable diagnosis. The data obtained based on the inference models may be fed into the insurance evaluation engine. The insurance evaluation engine may provide a patient or an attending physician with a future health status of the patient. Corresponding probabilities may be assigned to future health issues associated with the patient. The insurance evaluation engine may provide recommended treatment and patient management plans and perform tracking of a disease progress and a patient response to the treatment. The results can be determined by quality-adjusted life year (QALY) calculation. The QALY is a measure of disease burden, including both the quality and the quantity of life lived, and may be used in evaluations to assess the value for money of medical interventions.

In certain example embodiments, several derivative products may emerge as a direct result of the technical solutions described in the present disclosure, such as medical/life insurance models, data products (efficiency of treatment options, comparative analysis of drugs), specific patient-centric forecast models, unique scheduling algorithms (getting tests needed for diagnosis before a visit of a doctor), and unique advertising for drug companies, as well as doctor tracking. For example, if recommendations of the doctor consistently contradict the recommendations of the system for evaluating a cost of an insurance, patients with treatable illnesses may return to visit the doctor more frequently than they should (i.e., a number of visits may be greater than a predetermined number of visits for such illness and recommendations). Such information can be logged and reviewed by patients and hospital employees.

The insurance evaluation engine of the system for evaluating a cost of an insurance may have several advantages: 1) all potential diseases associated with any patient and set of symptoms may be considered; 2) the probability of each disease may be calculated; 3) outliers, in particular dangerous ones, may be identified; 3) missed questions with respect to symptoms may be automatically asked to render the most accurate statistical diagnosis possible; 4) tests that will enhance the probability of a condition or disease may be requested when necessary, sometimes in advance of seeing a doctor; 5) all the main disadvantages of clinical gestalt may be obviated; 6) the totality of medical clinical gestalt may be considered; 7) efficiency in traversing the network as opposed to reading through tables; and 8) ability to have probability distributions assigned to immediately available information.

The insurance evaluation engine of the system for evaluating a cost of an insurance can take the information from the first parser and the second parser, identify medical metadata and phrases, and plug the metadata and phrases into the causal network. If the information is coming from the EMR of the patient, the insurance evaluation engine may parse the information and create a patient clinical gestalt (for example, a general clinical picture associated with the patient) as a subnet of the causal network. The subnet of the causal network may include nodes that represent diseases, symptoms, treatments, states associated with the patient, and links between the nodes that may include dependencies between the nodes. The links in the subnet of the causal network may be statistically weighted, and the weights may be specific to the patient. The second parser may feed symptoms and other data to the insurance evaluation engine. The insurance evaluation engine may map the symptoms and other data against the causal network and identify the total subnet for these symptoms. The system for evaluating a cost of an insurance may allow recognizing a set of diseases, conditions, and states, and corresponding probabilities. Probability distributions may be assigned dynamically to the patient based on the characteristics of the patient, the probability distributions of the causal network, and the statistical database of the population of patients.

Systems and methods for evaluating a cost of an insurance described herein may allow a user of a computing device, such as a desktop computer, a laptop computer, a cell phone, a smart phone, or the like, to obtain a future health status of a patient and a cost of an insurance based on the future health status. The patient or an attending physician utilizing the system for evaluating a cost of an insurance may be further provided with a patient management plan designed to improve health conditions of the patient or prevent the development of possible health conditions.

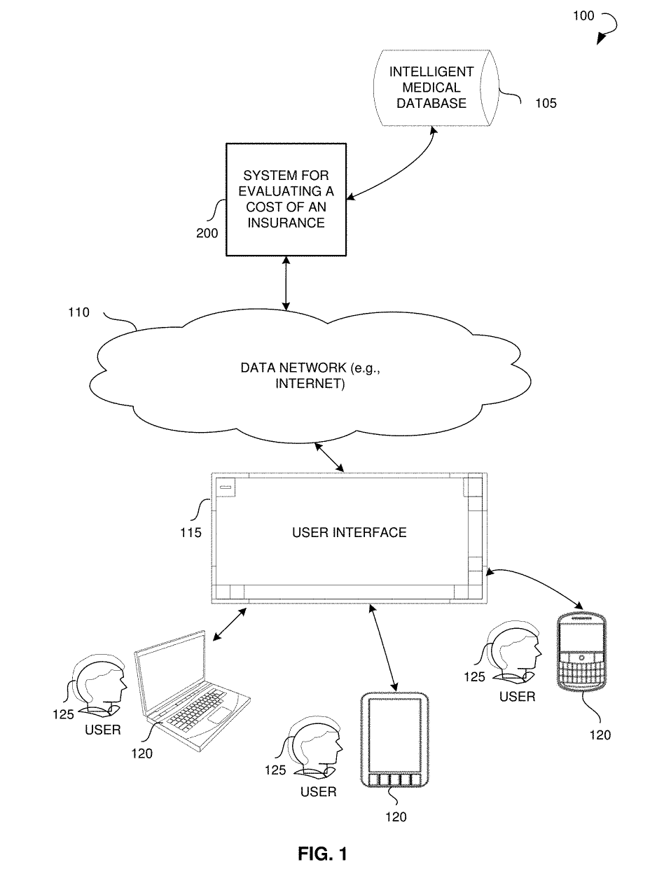

Referring now to the drawings, FIG. 1 is a block diagram showing a sample environment 100 within which methods and systems for evaluating a cost of insurance may be implemented, according to an example embodiment. The environment may include a data network 110, client devices 120, users 125, a user interface 115, a system 200 for evaluating a cost of an insurance, and an intelligent medical database 105.

The data network 110 may include the Internet or any other network capable of communicating data between devices. Suitable networks may include or interface with any one or more of, for instance, a local intranet, a corporate data network, a data center network, a home data network, a Personal Area Network, a Local Area Network, a Wide Area Network, a Metropolitan Area Network, a virtual private network, a storage area network, a frame relay connection, an Advanced Intelligent Network connection, a synchronous optical network connection, a digital T1, T3, E1 or E3 line, Digital Data Service connection, Digital Subscriber Line connection, an Ethernet connection, an Integrated Services Digital Network line, a dial-up port such as a V.90, V.34 or V.34bis analog modem connection, a cable modem, an Asynchronous Transfer Mode connection, or a Fiber Distributed Data Interface or Copper Distributed Data Interface connection. Furthermore, communications may also include links to any of a variety of wireless networks, including Wireless Application Protocol, General Packet Radio Service, Global System for Mobile Communication, Code Division Multiple Access or Time Division Multiple Access, cellular phone networks, Global Positioning System, cellular digital packet data, Research in Motion, Limited duplex paging network, Bluetooth radio, or an IEEE 802.11-based radio frequency network. The data network can further include or interface with any one or more of a Recommended Standard 232 (RS-232) serial connection, an IEEE-1394 (FireWire) connection, a Fiber Channel connection, an IrDA (infrared) port, a Small Computer Systems Interface connection, a Universal Serial Bus connection or other wired or wireless, digital or analog interface or connection, mesh or Digi® networking. The data network 110 may be a network of data processing nodes that may be interconnected for the purpose of data communication. The data network 110 may include any suitable number and type of devices (e.g., routers and switches) for forwarding commands, content, and/or web object requests between all data processing nodes connected to the data network 110.

The client devices 120 may include a personal computer (PC), a laptop, a smartphone, a tablet PC, a television set, a mobile phone, a smart phone, a gaming device, an Internet phone, a netbook, a home gateway, and so forth. In some example embodiments, the client devices 120 may include a Graphical User Interface (GUI) for displaying the user interface 115. In a typical GUI, instead of offering only text menus or requiring typed commands, the system 200 may present graphical icons, visual indicators, or special graphical elements called widgets that may be utilized to allow the users 125 to interact with the user interface 115. The client devices 120 may be configured to utilize icons used in conjunction with text, labels, or text navigation to fully represent the information and actions available to users.

In some example embodiments, the users 125 include persons interacting with the user interface 115 via the client devices 120. The users 125 may be users of the system 200 (for example, patients or physicians that use the system 200). The users 125 may periodically interact with the system 200 and provide various pieces of information to the system 200. The information provided by the users 125 may be stored in the intelligent medical database 105. In some example embodiments, the intelligent medical database 105 may be a component of the system 200. The information provided by the users 125 may include various medical knowledge relating to demographical characteristics, personal statistics, medical histories, medications, allergies, immunization statuses clinical diagnoses, symptoms, diseases, treatments, drug prescriptions, genetic histories, or laboratory test results, and the like. All medical knowledge may be represented as a sum of a set of binary relationships between elements of the intelligent medical database 105 including but not limited to: demographical characteristics, personal statistics, medical histories, medications, allergies, immunization statuses clinical diagnoses, symptoms, diseases, treatments, drug prescriptions, genetic histories, laboratory test results, and the like. Relationships between the elements may include but are not limited to: causes, effects, conditional likelihoods, and the like. The relationships may be further qualified by sex, age, and the like, which may include qualities and quantities associated with a patient. For example, smoking has a causal relationship to emphysema, a gastro-esophageal reflux disease (GERD) has a causal relationship to asthma, and a postal code of the patient may have a conditional likelihood relationship with a breast cancer. The intelligent medical database 105 may include a set of binary relationships of existent (known) medical knowledge and may include pathological relationships in some example embodiments.

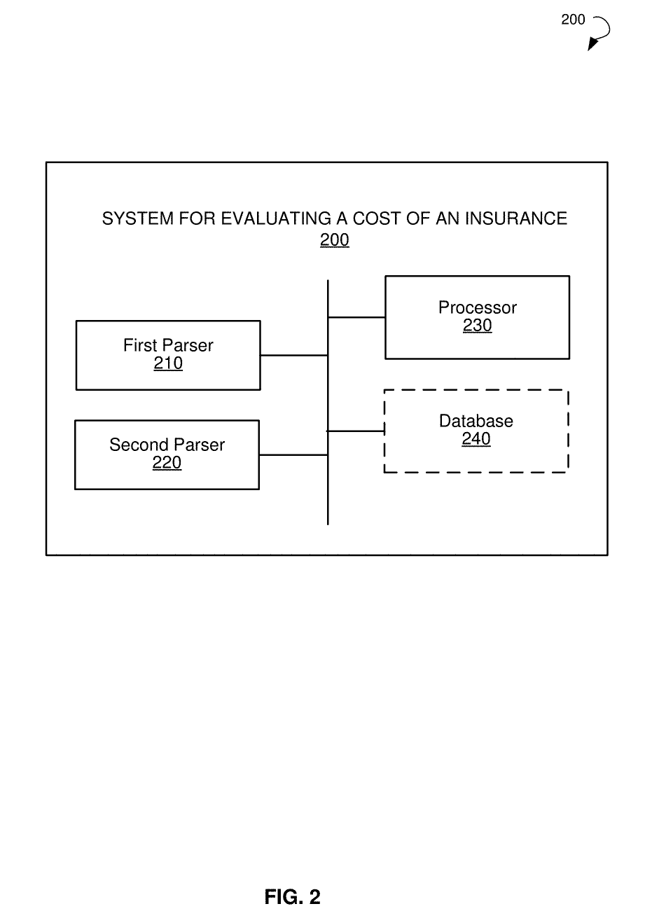

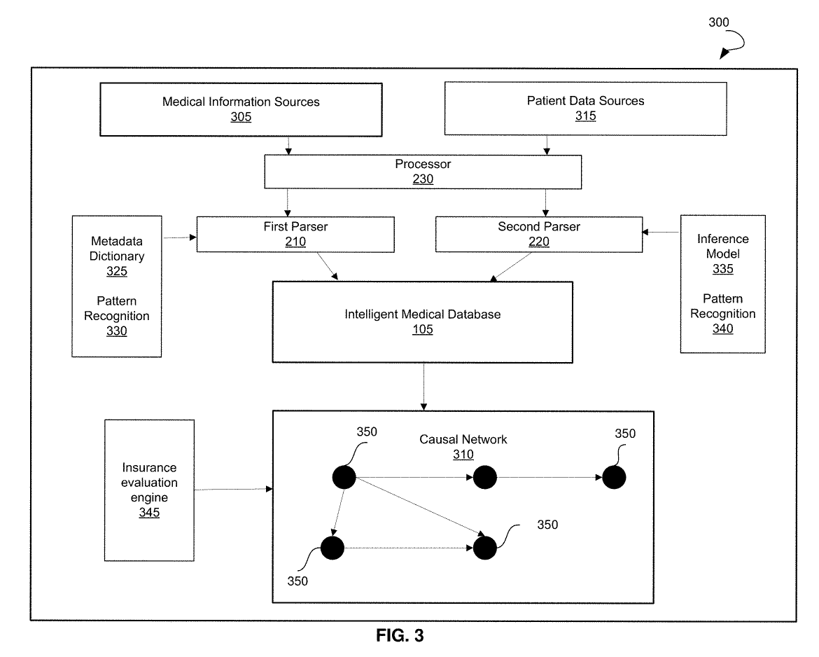

FIG. 2 is a block diagram illustrating a system 200 for evaluating a cost of an insurance, in accordance with an example embodiment. The system 200 may include a first parser 210, a second parser 220, a processor 230, and optionally a database 240. In an example embodiment, the database 240 may include an intelligence medical database 105 as shown on FIG. 1. The first parser 210, the second parser 220, and the processor 230 are described in detail with reference to FIG. 3

FIG. 3 is a block diagram 300 illustrating a system 200 for evaluating a cost of an insurance, in accordance with an example embodiment. The system 200 may include a processor 230, a first parser 210, and a second parser 220. The first parser 210 may be configured to parse a text from one or more medical information sources 305 to obtain statistical data associated with a population of patients. The processor 230 may be configured to structure the statistical data to form structured medical metadata in an intelligent medical database and create a causal network 310 based on the structured medical metadata. The structured medical metadata may include elements and relationships between the elements.

The processor 230 may be further configured to receive health data associated with a patient from one or more patient data sources. The second parser 220 may be configured to parse the health data associated with the patient to obtain processed patient health data. The processor 230 may map the processed patient health data against the causal network 310.

Furthermore, the processor 230 may be configured to predict future health status associated with the patient based on the mapping of the processed patient health data against the causal network 310. Finally, the processor 230 may be configured to evaluate the cost of the insurance associated with the patient based on the predicted future health status.

The first parser 210 may be used to parse a text associated with one or more medical information sources 305 to obtain statistical data associated with a population of patients. The first parser 210 may be further configured to create one or more backend structures based on the obtained statistical data associated with a population of patients. The one or more backend structures may form a framework against which the processed patient health data are mapped. The second parser 220 may be used to parse health data associated with a patient from one or more patient data sources 315 to obtain processed patient health data.

In certain example embodiments, the first parser 210 may use equivalence classes of medical terms and phrases found in a metadata dictionary 325. The first parser 210 may then use the metadata dictionary 325, along with pattern recognition 330, to pick up pertinent medical information associated with the population of patients and map the medical information against the backend structures. Such mapping may populate an intelligent medical database 105 with various medical terms and phrases associated with a population of patients, such as names of diseases, age, sex, medications, allergies, immunizations, diagnoses, symptoms, treatments, drugs, and the like. The medical terms and phrases may be referred to as elements of the intelligent medical database 105.

In certain example embodiments, the first parser 210 may build relationships between the elements of the intelligent medical database 105. For example, the first parser 210 may build a relationship between two diseases, such as asthma and GERD, in the intelligent medical database 105. The first parser 210 may be responsible for mapping medical articles, electronic medical records, a Unified Medical Language System, a Systematized Nomenclature of Medicine, doctor inputs, and medical journals to the intelligent medical database 105. For example, upon predefining the concept of a symptom, the first parser 210 may understand, using the pattern recognition 330, the word or phrase and appropriately place the word or phrase in the structure of the intelligent medical database 105.

The medical metadata may be constantly updated and appended to reflect additions and alterations associated with the one or more medical information sources 305. As new journals are published and accepted by a medical community, new drugs are developed and new diseases are discovered, treatment data changes, and/or new records appear in electronic medical records, the first parser 210 may read, decode, and update the medical metadata to reflect the additions and alterations. Correlations between previously unconnected diseases may be formalized and the medical metadata may be updated to reflect the changes. The entire process may be auditable at many points by medical professionals.

In certain example embodiments, the second parser 220 may use an inference model 335, a medical lexicon, and a pattern recognition 340 to obtain important information from one or more patient data sources and disregard information that is not important. It is important to note that the second parser 220 may not be a grammar-based parser. This is imperative for the system 200 that reports are communicated clearly. Additionally, the lack of syntactic algorithms may allow the system 200 to be translated easily into any language without a complete rewrite of the parser logic.

The second parser 220 may take demographical characteristics, personal statistics, medical histories, medications, allergies, immunization statuses, clinical diagnoses, symptoms, diseases, treatments, drug prescriptions, genetic histories, laboratory test results, and the like and build a user case for a patient, prompting for any information that requires attention, such as, for example sex, age, and the like. This information may provide the context for the responses with appropriate pattern recognition and keywords that are acceptable as a response. The second parser 220 may be provided with the intelligence to understand the relevance of phrases submitted. For example, someone may input that a person is “feeling it is difficult to breathe,” and the second parser 220 may have this phrase listed as a symptom. The second parser 220 may then provide this phrase to a symptom node 350 in a causal network 310, rapidly traversing the causal network 310 to ascertain all possible diagnoses.

The second parser 220 may be aided by the inference model 335. If a patient inputs “my heart aches for my lost love,” for example, the inference may be “the patient is having chest pains.”

The second parser 220 may take natural language and identify symptoms of the patient and the severity of these symptoms based on artificial intelligence of the pattern recognition 330. There may be no grammar base for the parsing; therefore, the artificial intelligence of the pattern recognition 330, apart from the metadata and phrase library, may be language independent.

The second parser 220 may feed patient health data to an insurance evaluation engine 345. The insurance evaluation engine 345 may be configured in a form of an individual node. In other example embodiments, the functions of the insurance evaluation engine 345 may be performed by the processor 230. The insurance evaluation engine 345 may map the patient health data against the causal network 310 and identify a future health status associated with a patient. The insurance evaluation engine 345 may further predict healthcare expenses associated with the future health status of the patient and evaluate the cost of an insurance based on the predicted future health status.

The insurance evaluation engine 345 may include a list of questions and possible tests. For each specific case, the insurance evaluation engine 345 may formulate and immediately ask questions to better rank the possibilities for future health status. Responses may be refactored into a diagnosis and a ranked assessment may be made.

The insurance evaluation engine 345 may determine a new set of questions and tests needed to accomplish several tasks, such as: 1) identify or eliminate any serious conditions (sometime outliers); 2) refine the likelihood of any of ranked conditions identified; 3) shorten the list of possibilities; 4) arrive at a high likelihood for a diagnosis; 5) decide to throw the case directly to a doctor because the insurance evaluation engine 345 has no confidence in the diagnosis (statistically).

The insurance evaluation engine 345 may be configured to traverse the causal network 310 in multiple directions or paths, and identify additional or corroborating symptoms, conditions, treatments and states (amongst other relationships) along with the corresponding likelihoods. In particular, for each potential disease or condition identified, associated diseases, symptoms, and outcomes may be calculated and likelihood functions assigned (i.e., the likely condition of the patient and the likely outcomes for a set of treatment options). If the likelihood falls under a certain threshold, the insurance evaluation engine 345 may not render any decisions or diagnoses.

The insurance evaluation engine 345 may predict a future health status of a patient with a list of possible diseases or conditions, and refine the future health status based on periodically received health data associated with the patient, and also based on the results of queries and/or requested tests. The refinement, or a set of refinements, may be used to eliminate dangerous outcomes, even if they are outliers, and to disregard any information that does not affect the likelihood of the future health status.

In certain example embodiments, the insurance evaluation engine 345 may evaluate a cost of an insurance based on the predicted future health status associated with the patient. The future health status may be essentially a subnet of the causal network 310 with a probability distribution for the subnet. The subnet may contain multiple diagnoses, which may be concurrent or alternatives with varying probabilities. The future health status may be the most likely set of concurrent discrete paths in the subnet. The insurance evaluation engine 345 may be used for understanding severity and acuteness of patient conditions. Traditionally, severity and acuteness of patient conditions have been difficult to determine due to the subjectivity of the patient response and the absence of a reliable measurement mechanism.

The insurance evaluation engine 345 may have additional capability of interpreting pain from the perspective of a disease or condition. For example, if the pain is likely associated with appendicitis, then the insurance evaluation engine 345 may have plenty of options with regard to the location(s) and acuteness of the pain, pain variations, and associated outliers.

Upon establishing the future health status, the processor 230 may proceed with determining appropriate patient care. Typically, if a doctor prescribes a treatment that works, the patient does not return to visit the doctor. If, however, the treatment does not work, the patient returns and the condition of the patient may get worse.

Therefore, the system for evaluating a cost of insurance may provide, within statistical boundaries, the results of medication/care over the course of the treatment. By getting a constant feedback from the patient over the course of the treatment regimen of the patient, doctors and patients can quickly determine if the correct diagnosis or treatment option was selected. If, for example, the patient apparently suffering from asthma only at night was placed on a treatment program for acid reflux, and after a week the patient does not experience any improvement, the system for evaluating a cost of an insurance may respond accordingly by changing the treatment program for the patient.

Moreover, the system for evaluating a cost of an insurance may be able to provide the patient with a prognosis within statistical boundaries of the results, risks, and consequences of treatment or lack thereof, thus allowing the patient/doctor to act on a full knowledge set and come to a conclusion about the treatment program for the patient given the circumstances.

Using the causal network 310 and probability assignments of the causal network 310, the system for evaluating a cost of an insurance may make it possible to predict future patient profiles, identify diseases and treatments, progress of diseases and consequences that the diseases and treatments may have for a patient in the future, together with treatments that the patient may receive. This approach may provide a unique insight into the medical and life insurance that the patient may need and the healthcare costs associated with the patient.

Using the causal network 310 and the statistical data from the patient population, more accurate predictions of drug use and other necessary treatments may be made for the patient population. Additionally, mortality and morbidity predictions, with and without treatment, may be made. Screening requirements for individuals within the patient population may be determined from the statistical tables and implemented preventative measures.

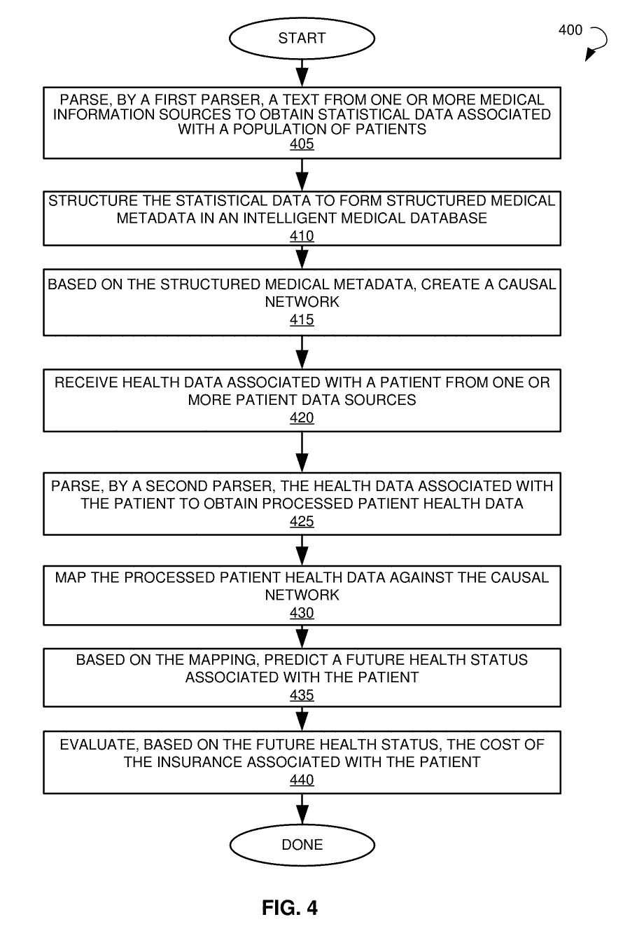

FIG. 4 is a process flow diagram illustrating a method 400 for evaluating a cost of an insurance, in accordance with an example embodiment. In some embodiments, the operations may be combined, performed in parallel, or performed in a different order. The method 400 may also include additional or fewer operations than those illustrated. The method 400 may be performed by processing logic that may include hardware (e.g., decision making logic, dedicated logic, programmable logic, and microcode), software (such as software run on a general-purpose computer system or a dedicated machine), or a combination of both.

The method 400 may commence with parsing, by a first parser, a text from one or more medical information sources to obtain statistical data associated with a population of patients, at operation 405. In an example embodiment, the one or more medical information sources may include electronic medical records, a Unified Medical Language System, a Systematized Nomenclature of Medicine, and so forth. The statistical data associated with the population of patients may include demographical characteristics, personal statistics, medical histories, medications, allergies, immunization statuses, clinical diagnoses, symptoms, diseases, treatments, drug prescriptions, genetic histories, laboratory test results, and so forth. At operation 410, the statistical data may be structured to form structured medical metadata in an intelligent medical database. The structured medical metadata may include elements and relationships between the elements. The elements of the structured medical metadata may include one or more of the following: a disease, a state, a cause, a symptom, a treatment, a test, an effect, an outcome, an outlier, and so forth. At operation 415, a causal network may be created based on the structured medical metadata.

The method 400 may proceed with receiving health data associated with a patient from one or more patient data sources, at operation 420. The health data from one or more patient data sources may be processed using an inference model and pattern recognition. In some example embodiments, the health data associated with the patient may include a patient input in a form of one or more of the following: a natural language, a text, and a speech.

At operation 425, the health data associated with the patient may be parsed, by a second parser, to obtain processed patient health data. The processed patient health data may further be mapped against the causal network at operation 430. Based on the mapping, the future health status associated with the patient may be predicted at operation 435. Finally, at operation 440, the cost of the insurance associated with the patient may be evaluated based on the predicted future health status.

In an example embodiment, each of the first parser and the second parser may include a grammar independent natural language parser configured to retrieve, interpret, and collate medical information from the one or more medical information sources. The text from one or more medical information sources parsed by the first parser may include the medical information. The medical information may be obtained from the one or more medical information sources using a metadata dictionary and pattern recognition. The metadata dictionary may include an equivalence class of terms and phrases associated with a medical lexicon.

The method 400 may further include generating a patient management plan for the patient. The patient management plan may be generated based on the future health status associated with the patient and the cost of the insurance. The generating the patient management plan may include determining treatment to be provided to the patient according to the health data associated with the patient. In an example embodiment, the method 400 may include tracking a patient response to the treatment during and after the treatment according to the patient management plan. The method 400 may further include periodically receiving further health data associated with the patient and refining the future health status based on the further health data. Additionally, the method 400 may include assigning probabilities to future health issues associated with the future health status. In a further example embodiment, the method 400 may include dynamically updating the structured medical metadata to reflect additions and modifications associated with the one or more medical information sources.

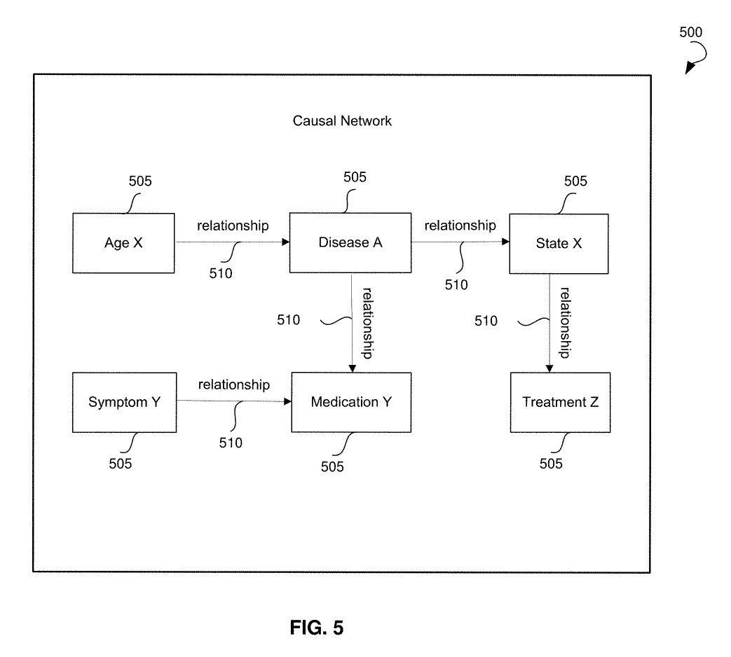

FIG. 5 illustrates a causal network 500, in accordance with an example embodiment. The causal network 500 may include a unique morphology for storing and representing medical knowledge that imbues a unique behavior. The causal network 500 may display a rich set of characteristics, which may substantially enhance the prediction of a future health status of a patient. The causal network 500 may show a potential totality of demographical characteristics, personal statistics, medical histories, medications, allergies, immunization statuses, medical conditions, causes, symptoms, treatments, outcomes, drug prescriptions, genetic histories, and laboratory test results, and other relationships, together with the probability distribution of such relationships based on the experience of a population of patients and knowledge embedded into the system 200 for evaluating a cost of an insurance shown on FIGS. 2 and 3.

The causal network 500 may be a path-connected topological space that may include nodes 505 that represent diseases (Disease A), symptoms (Symptom Y), treatments (Treatment Z), states (State X), personal statistics (Age X), medications (Medication Y), and the like and links 510 between the nodes 505. More specifically, the nodes 505 may represent the elements of an intelligent medical database. The links 510 may be characterized by relationships among the elements and may include directed dependencies between the nodes 505. The links 510 (i.e., the relationships) in the causal network 500 may be dynamically statistically weighted based on patient profile, patient data, and other population data. Weights assigned to the links 510 may be specific to the patient as a case history of the patient may influence the probabilities of the causal network 500.

The nodes 505 and links 510 of the causal network 500 may form a pattern recognition natural language for medical knowledge. The causal network 500 may define medical metadata, the relationships that may exist between metadata elements, and the manner in which the metadata elements can reference each other. In certain example embodiments, building of the causal network 500 may include mapping the relationships into an adjacency matrix, and the adjacency matrix may be used to construct a path matrix.

The causal network 500 may represent various ways in which the elements of the intelligent medical database can relate to each other. For example, symptoms may be related to diseases, diseases may be related to outcomes, symptoms may be related to outcomes, diseases may be related to treatments, and so force.

Furthermore, the nature of the relationships can carry additional information and qualification, such as likelihood or severity. In the case of likelihood, the relationship can carry a statistical value qualified by different attributes. For example, A might be related to B with a probability of X based on the qualification (a patient is male, over 55 years old and has other attributes).

The likelihood or probability distribution for each of the relationships, or for combinations of the relationships, may be calculated based on statistical information from a population of patients and from clinical tests. These probability distributions may be further enhanced by characteristics of an individual patient for which the cost of an insurance may be evaluated.

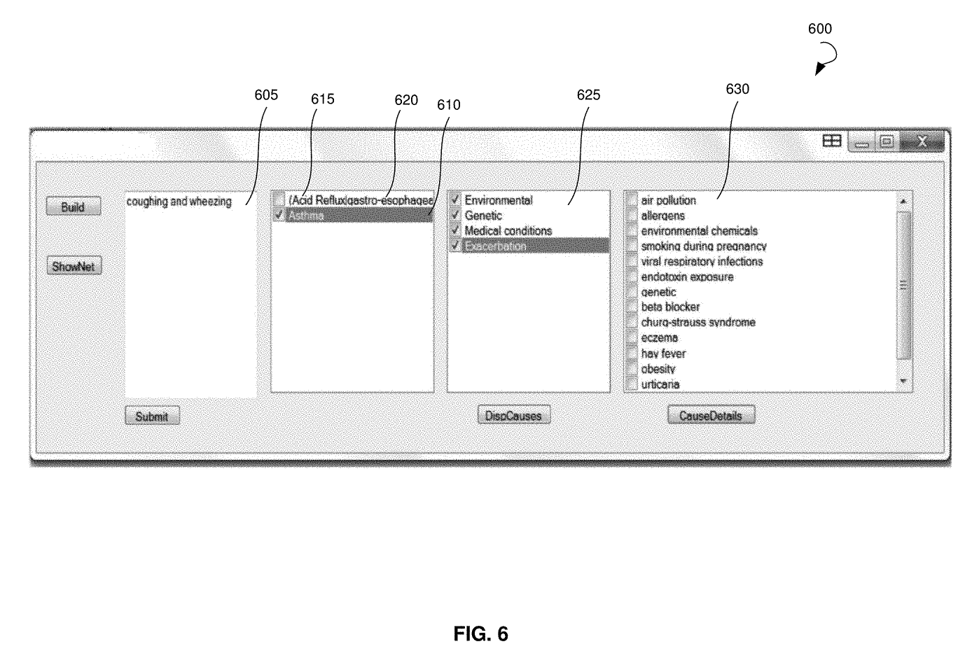

FIG. 6 illustrates a user interface for a metadata library 600, in accordance with an example embodiment. The metadata library 600 may include a structured medical metadata obtained by means of pattern recognition of natural language associated with medical knowledge. The structured medical metadata may include elements and relationships that exist between the elements of the medical metadata, and the manner in which the elements can reference each other. In addition, the metadata library 600 may include a number of metadata dictionaries with equivalence classes of medical terms and phrases, so that the elements of the medical metadata that are the same can be treated the same.

A metadata dictionary may include an equivalence class of terms and phrases associated with a medical lexicon. The equivalency may be important because different standards have different terminologies to describe the same disease, condition, symptom, and so forth. For example, most patients may know about “Nexium” but most physicians probably use “esomeprazole” to refer to the same drug. The metadata dictionary may include a third-party metadata dictionary and may need to be imported. In an example embodiment, the metadata dictionary may include a metadata dictionary from the National Institutes of Health (NIH), National Institute for Health and Clinical Excellence (NICE), Systematized Nomenclature of Medicine (SNOWMED), or the index of medical textbooks.

In certain example embodiments, pattern recognition functionality may be added to the metadata library 600. The pattern recognition may use an equivalence class dictionary of terms and phrases that provides an exhaustive cover of the medicine lexicon. Across standards, languages, and different nomenclatures, when two words or phrases describe the same disease, condition, symptom, and so forth, these two words may be placed into the same equivalence class and treated as a single entity. This is important because patients often do not use the same terminology as the doctors, yet the patients and the doctors need to communicate to achieve an understanding of symptoms and diseases.

In certain example embodiments, the metadata library 600 may be built using a standard set of medical libraries such as Unified Medical Language System (UMLS), Systematized Nomenclature of Medicine Clinical Terms (SNOWMED CT), and the like.

The metadata library 600 may be constructed with a list of diseases, a set of symptoms that may be observed in a patient suffering from diseases, a list of tests and tools to confirm or reject a disease as a diagnosis, known relationships between triggers or causes of diseases, such as environmental factors, genetic history, postal codes, workplace factors, patient age/sex/medical history, and the like. The metadata library 600 may additionally include relationships to other diseases and conditions, complete with treatment options.

FIG. 6 illustrates a simplified example for the construction of a binary relationship (symptoms and causes) for asthma using the metadata library 600. A static medical metadata and a phrase library may be used. In this example, inputs 605 may include coughing and wheezing. The first parser may identify two diseases: asthma 610 and acid reflux 615, and may pull all the causes and symptoms associated with the diseases.

The metadata library 600 may include the following:

Disease Metadata: asthma 610, acid reflux 615, and GERD 620.

Context Metadata 625: signs and symptoms, causes, diagnosis, management, and treatment.

Symptom Metadata (shown by the inputs 605): coughing, wheezing, chest tightness, shortness of breath, heartburn, regurgitation, trouble swallowing, dysphasia, sore throat, odynophasia, pain with wallowing, nausea, chest pain, globus (pharingeus, hystericus), lump in throat, and so forth.

Causes Metadata 630: low air quality, allergens, air pollution, environmental chemicals, smoking during pregnancy, formaldehyde exposure, endotoxin exposure, phthalates in polyvinyl chloride, endotoxin exposure, viral respiratory infections, genetic, history of atopic disease, eczema, hay fever, Churg-Strauss syndrome, urticarial, vasculitis, beta blocker, psychological stress, genetic, gastro-esophageal reflux disease, obstructive sleep apnea, obesity, rhinosinusitis, Hiatal hernia, Zollinger-Ellison syndrome, hypercalcemia, scleroderma, systemic sclerosis, prednisolone, gallstones, Visceroptosis/Gléenard syndrome, and so forth.

Testing Metadata (not shown): spirometry, single-breath diffusing capacity, peak expiratory flow rate, esophageal pH monitoring, barium swallow X-rays, esophageal manometry, esophagogastroduodenoscopy, and short-term treatment with proton-pump inhibitors.

Treatment Metadata (not shown): salbutamol (the United States Adopted Name is albuterol), ipratropium bromide, anticholinergic bronchodilators, corticosteroids, beta-adrenoceptor agonists, leukotriene antagonists, oxygen, magnesium sulfate, heliox, intravenous salbutamol, methylxanthines, ketamine, diet, sleeping on the left side, antibiotics, proton-pump inhibitors, omeprazole, esomeprazole, pantoprazole, lansoprazole, rabeprazole, gastric H2 receptor blockers, ranitidine, famotidine, cimetidine, antacids, alginic acid, gaviscon, reglan, metoclopramide, prokinetic, sucralfate, carafate, mosapride citrate, 5-hydroxytryptamine receptor 4 (5-HT₄ receptor) agonist, baclofen, agonist of gamma-aminobutyric acid (GABA_{B}) receptors, Nissen fundoplication, and transoral incisionless fundoplication.

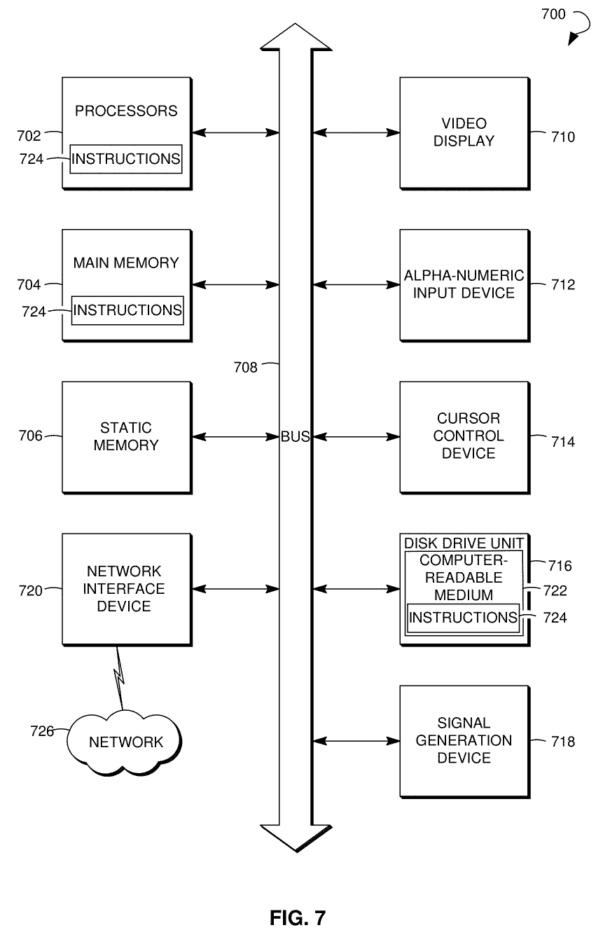

FIG. 7 illustrates a diagrammatic representation of an example machine in the form of a computer system within which a set of instructions for causing the machine to perform any one or more of the methodologies discussed herein is executed. A computer system 700 may include a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a PC, a tablet PC, a set-top box, a tablet computer, a cellular telephone, a smartphone, a portable music player (e.g., a portable hard drive audio device such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 700 may include a processor or multiple processors 702 (e.g., a central processing unit, a graphics processing unit, or both), a main memory 704, and a static memory 706, which communicate with each other via a bus 708. The computer system 700 may further include a video display unit 710 (e.g., a liquid crystal display or a cathode ray tube). The computer system 700 may also include an alphanumeric input device 712 (e.g., a keyboard), a cursor control device 714 (e.g., a mouse), a disk drive unit 716, a signal generation device 718 (e.g., a speaker), and a network interface device 720.

The disk drive unit 716 may include a computer-readable medium 722, on which is stored one or more sets of instructions and data structures (e.g., instructions 724) embodying or utilized by any one or more of the methodologies or functions described herein. The instructions 724 may also reside, completely or at least partially, within the main memory 704 and/or within the processors 702 during execution thereof by the computer system 700. The main memory 704 and the processors 702 may also constitute machine-readable media.

The instructions 724 may further be transmitted or received over a network 726 via the network interface device 720 utilizing any one of a number of well-known transfer protocols (e.g., Hyper Text Transfer Protocol).

While the computer-readable medium 722 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, flash memory cards, digital video disks, random access memory, read only memory, and the like.

The example embodiments described herein may be implemented in an operating environment comprising software installed on a computer, in hardware, or in a combination of software and hardware.

Thus, systems and methods for evaluating a cost of an insurance have been described. Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

What is claimed is:

1. A system for evaluating a cost of an insurance, the system comprising:
a first parser configured to:
parse a text from one or more medical information sources to obtain statistical data associated with a population of patients;
a second parser configured to:
parse health data associated with a patient to obtain processed patient health data; and
a processor configured to:
structure the statistical data to form structured medical metadata in an intelligent medical database;
based on the structured medical metadata, create a causal network;
receive the health data associated with the patient from one or more patient data sources;
map the processed patient health data against the causal network;
based on the mapping, predict a future health status associated with the patient; and
evaluate, based on the future health status, the cost of the insurance associated with the patient.

2. The system of claim 1, wherein the structured medical metadata comprise elements and relationships between the elements.

3. The system of claim 2, wherein the elements of the structured medical metadata include one or more of the following: a disease, a state, a cause, a symptom, a treatment, a test, an effect, an outcome, and an outlier.

4. The system of claim 1, wherein the one or more medical information sources include electronic medical records, a Unified Medical Language System, and a Systematized Nomenclature of Medicine.

5. The system of claim 1, wherein each of the first parser and the second parser includes a grammar independent natural language parser configured to retrieve, interpret, and collate medical information from the one or more medical information sources, wherein the text from one or more medical information sources includes the medical information.

6. The system of claim 5, wherein the medical information is obtained from the one or more medical information sources using a metadata dictionary and pattern recognition.

7. The system of claim 6, wherein the metadata dictionary includes an equivalence class of terms and phrases associated with a medical lexicon.

8. The system of claim 1, wherein the statistical data associated with the population of patients include demographical characteristics, personal statistics, medical histories, medications, allergies, immunization statuses, clinical diagnoses, symptoms, diseases, treatments, drug prescriptions, genetic histories, and laboratory test results.

9. The system of claim 1, wherein the health data associated with the patient is processed using an inference model and pattern recognition.

10. The system of claim 1, wherein the health data associated with the patient includes a patient input in a form of one or more of a natural language, a text, and a speech.

11. The system of claim 1, wherein the processor is further configured to generate a patient management plan for the patient.

12. The system of claim 11, wherein the processor is further configured to track a patient response to treatment during and after the treatment according to the patient management plan.

13. The system of claim 1, wherein the processor is further configured to dynamically update the structured medical metadata to reflect additions and modifications associated with the one or more medical information sources.

14. A method for evaluating a cost of an insurance, the method comprising:
parsing, by a first parser, a text from one or more medical information sources to obtain statistical data associated with a population of patients;
structuring, by a processor, the statistical data to form structured medical metadata in an intelligent medical database;
based on the structured medical metadata, creating, by the processor, a causal network;
receiving, by the processor, health data associated with a patient from one or more patient data sources;
parsing, by a second parser, the health data associated with the patient to obtain processed patient health data;
mapping, by the processor, the processed patient health data against the causal network;
based on the mapping, predicting, by the processor, a future health status associated with the patient; and
evaluating, by the processor, based on the future health status, the cost of the insurance associated with the patient.

15. The method of claim 14, further comprising generating a patient management plan for the patient.

16. The method of claim 15, further comprising tracking a patient response to treatment during and after the treatment according to the patient management plan.

17. The method of claim 14, further comprising:
periodically receiving further health data associated with the patient; and
refining the future health status based on the further health data.

18. The method of claim 14, further comprising assigning probabilities to future health issues associated with the future health status.

19. The method of claim 14, further comprising dynamically updating the structured medical metadata to reflect additions and modifications associated with the one or more medical information sources.

20. A system for evaluating a cost of an insurance, the system comprising:
a first parser configured to:
parse a text from one or more medical information sources to obtain statistical data associated with a population of patients;
a second parser configured to:
parse health data associated with a patient to obtain processed patient health data; and
a processor configured to:
structure the statistical data to form structured medical metadata in an intelligent medical database;
based on the structured medical metadata, create a causal network;
receive the health data associated with the patient from one or more patient data sources;
map the processed patient health data against the causal network;
based on the mapping, predict a future health status associated with the patient; and
evaluate, based on the future health status, the cost of the insurance associated with the patient;
generate a patient management plan for the patient;
track a patient response to treatment during and after the treatment according to the patient management plan;
periodically receive further health data associated with the patient;
refine the future health status based on the further health data; and
dynamically update the structured medical metadata to reflect additions and modifications associated with the one or more medical information sources.
